(19) United States
(12) Patent Application Publication
(10) Pub. No.: US 2025/0044522 A1
(43) Pub. Date: Feb. 6, 2025

(54) APPARATUS FOR ALIGNING MULTIPLE FIBERS

(71) Applicant: Lumentum Operations LLC, San Jose, CA (US)

(72) Inventors: Ramunas WIERZBICKI, San Jose, CA (US); Michael LOVELADY, Mountain View, CA (US); Richard D. FAULHABER, San Carlos, CA (US)

(21) Appl. No.: 18/504,508

(22) Filed: Nov. 8, 2023

Related U.S. Application Data
(60) Provisional application No. 63/516,646, filed on Jul. 31, 2023.

(51) Int. Cl. G02B 6/36

(52) U.S. Cl. CPC G02B 6/3616

(57) ABSTRACT

In some implementations, an apparatus for aligning multiple fibers may comprise a lattice structure that comprises a plurality of tensioned elements to provide a deformable support framework to simultaneously position a plurality of optical fibers such that the plurality of optical fibers is elastically constrained in a first axis and a second axis. The apparatus may further comprise an array that comprises a plurality of micro-jaw structures passing through the lattice structure. In some implementations, each micro-jaw structure in the array of micro-jaw structures is adjustable to shift one or more positions of one or more optical fibers included among the plurality of optical fibers relative to one or more cores of a multi-core optical fiber.

### CROSS-REFERENCE TO RELATED APPLICATION

This patent application claims priority to U.S. Provisional Patent Application No. 63/516,646, filed on Jul. 31, 2023, and entitled “APPARATUS FOR ALIGNING MULTIPLE FIBERS.” The disclosure of the prior Application is considered part of and is incorporated by reference into this patent application.

### TECHNICAL FIELD

The present disclosure relates generally to fiber splicing and to an apparatus and method for aligning multiple individual fibers in a fiber bundle with a multi-core fiber to be spliced to the fiber bundle.

### BACKGROUND

Fiber optic splicing is a process that is used to join two separate fiber optic cables. There are numerous use cases for fiber optic splicing, including extending the length of a fiber to make the fiber long enough to be used in a required cable run, to repair severed fiber optic cables that are buried underground, to rejoin fiber optic cables that are inadvertently broken, and/or to otherwise connect fiber ends such that light from one fiber can travel into another fiber while minimizing optical power loss. In some cases, a semi-permanent connection can be made between two optical fibers using a mechanical splice, where two optical fibers are precisely aligned and held in place with a self-contained assembly rather than a permanent bond. Mechanical splicing is usually used when splices need to be made quickly and easily (e.g., to temporarily connect optical fibers during installation). Alternatively, two optical fibers can be permanently joined through fusion splicing, where a machine or electric arc is used to produce heat and fuse or weld glass ends that are precisely aligned for continuous light transmission.

### SUMMARY

In some implementations, an apparatus for aligning multiple fibers includes a lattice structure that comprises a plurality of tensioned elements to provide a deformable support framework to simultaneously position a plurality of optical fibers such that the plurality of optical fibers is elastically constrained in a first axis and a second axis; and an array that comprises a plurality of micro-jaw structures passing through the lattice structure, wherein each micro-jaw structure in the array is adjustable to shift one or more positions of one or more optical fibers included among the plurality of optical fibers relative to one or more cores of a multi-core optical fiber.

In some implementations, a method for aligning multiple fibers includes forming a fiber bundle that includes a plurality of optical fibers arranged in a pattern that corresponds to a pattern associated with a multi-core fiber; constraining the plurality of optical fibers in a first axis and a second axis using a multi-fiber alignment tool, wherein the multi-fiber alignment tool comprises: a plurality of tensioned elements to provide a deformable support framework to simultaneously position the plurality of optical fibers such that the plurality of optical fibers is elastically constrained in the first axis and the second axis; and a plurality of micro-jaw structures passing through a lattice structure that includes the plurality of tensioned elements; adjusting the multi-fiber alignment tool to align each individual optical fiber, of the plurality of optical fibers, with a respective core of the multi-core fiber; and splicing each individual optical fiber, of the plurality of optical fibers, with a respective core of the multi-core fiber that is aligned with the individual optical fiber.

In some implementations, a multi-fiber alignment system includes a plurality of tensioned elements to provide a deformable support framework to simultaneously position a plurality of optical fibers such that the plurality of optical fibers is elastically constrained in a first axis and a second axis; a plurality of micro-jaw structures passing through a lattice structure, wherein each micro-jaw structure, of the plurality of micro-jaw structures, is adjustable to shift one or more positions of one or more optical fibers included among the plurality of optical fibers relative to one or more cores of a multi-core optical fiber; and a ring-like structure for tensioning the plurality of tensioned elements inside an opening of the ring-like structure and for positioning the plurality of tensioned elements in a plane of the plurality of micro-jaw structures.

### BRIEF DESCRIPTION OF THE DRAWINGS

FIG. 1 is a diagram illustrating an example of a multi-fiber splicing clamp.

FIGS. 2A-2D are diagrams illustrating one or more examples of an apparatus that can be used to simultaneously align multiple individual fibers in a fiber bundle to a multi-core fiber.

FIG. 3 is a flowchart of an example process associated with aligning multiple fibers.

### DETAILED DESCRIPTION

The following detailed description of example implementations refers to the accompanying drawings. The same reference numbers in different drawings may identify the same or similar elements.

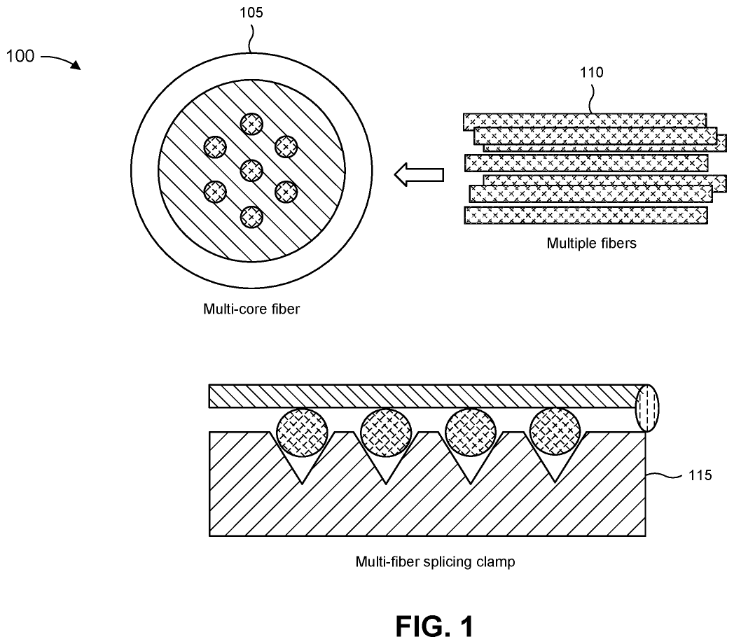

FIG. 1 is a diagram illustrating an example 100 of a multi-fiber splicing clamp. In general, an optical fiber may have a single core that is usually located on an axis of the optical fiber, or an optical fiber may include multiple cores that are arranged in a particular pattern. For example, an optical fiber may include multiple cores (generally referred to as a multi-core fiber or a multicore fiber) that are arranged in one or more rings around the fiber axis, a central core surrounded by additional cores that are arranged in one or more rings, or multiple cores that are otherwise arranged in a two-dimensional pattern. For example, FIG. 1 illustrates a multi-core fiber 105 that includes seven cores, with one central core surrounded by six cores that form a hexagonal lattice structure. However, it will be appreciated that the multi-core fiber 105 may include multiple cores that are arranged in any suitable two-dimensional pattern on a two-dimensional grid, with or without or a central core (e.g., a hexagonal pattern, a square pattern, a star-shaped pattern, or a random pattern). In principle, each fiber core in the multi-core fiber 105 can function as a separate waveguide, such that light can independently propagate through the respective cores.

However, in applications where the multi-core fiber 105 is to be spliced to multiple individual fibers 110 in a fiber bundle (e.g., in a master oscillator power amplifier (MOPA) where the master oscillator and/or power amplifier is implemented using a multi-core fiber), splicing the multiple individual fibers 110 to the multi-core fiber 105 generally requires simultaneous precise and independent alignment of the individual fibers 110. Aligning each individual fiber 110 with a respective core of the multi-core fiber 105 poses challenges, however, because the individual fibers 110 are typically tightly spaced together to the respective core in the multi-core fiber 105 to which the individual fibers 110 are being spliced. Furthermore, splicing tools are limited to manipulating only a single fiber or a group of fibers, and do not support individually manipulating multiple fibers. For example, existing splicing tools are typically designed as rigid grippers that are able to handle only the manipulation of a single fiber. Furthermore, to the extent that there are splicing tools for manipulating a group of fibers simultaneously, such as the multi-fiber splicing clamp 115 shown in FIG. 1, are typically bulky, limited to holding fibers in the same plane, not well-controlled, and ill-suited for splicing multiple fibers to a single multi-core fiber. Alternatively, individual fibers 110 may be spliced to each core of a multi-core fiber 105 one at a time. However, individually splicing each fiber 110 to a respective core of the multi-core fiber 105 is an extremely fragile process that requires multiple heating steps for each splice, which is unsuitable for manufacturing due to weakening the individual splices and the glass. Splicing the individual fibers 110 one at a time also limits how close the fibers 110 can be to each other due to the heat-affected zone of the previous splice.

Accordingly, some implementations described herein relate to an apparatus and method for aligning multiple fibers, which may provide a mechanism to splice multiple fibers with one fusion step. For example, some implementations described herein relate to an apparatus and a method that may provide a closely packed set of fibers that can be precisely controlled during an alignment phase such that only one fusion step is needed to splice the multiple fibers to a multi-core fiber. For example, in some implementations, a multi-fiber alignment tool may include one or more rigid elements to control respective positions of multiple fibers in at least a first axis and a second axis (e.g., an x-axis direction and a y-axis direction), and one or more tensile elements to provide a deformable support framework. For example, as described herein, the multi-fiber alignment tool may include a lattice structure with various tensioned elements to provide a deformable support framework to simultaneously position multiple optical fibers such that the multiple optical fibers are elastically constrained in a first axis and a second axis, and an array of micro-jaw structures that pass through the lattice structure. Accordingly, each micro-jaw structure is adjustable to shift one or more positions of one or more of the optical fibers relative to one or more cores of a multi-core optical fiber.

FIG. 1 is provided as an example. Other examples may differ from what is described with regard to FIG. 1. The number and arrangement of devices shown in FIG. 1 are provided as examples. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

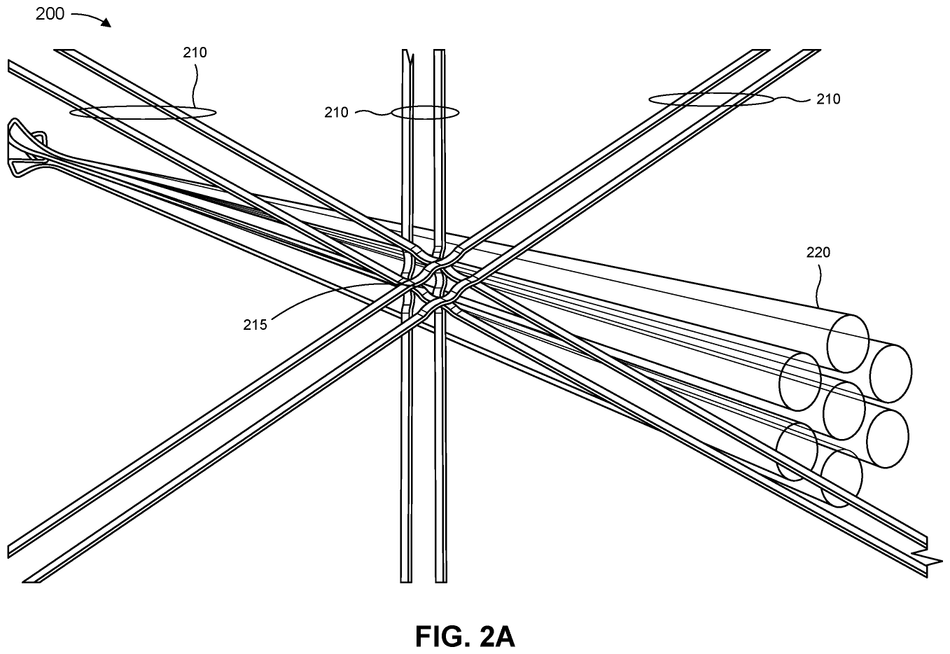

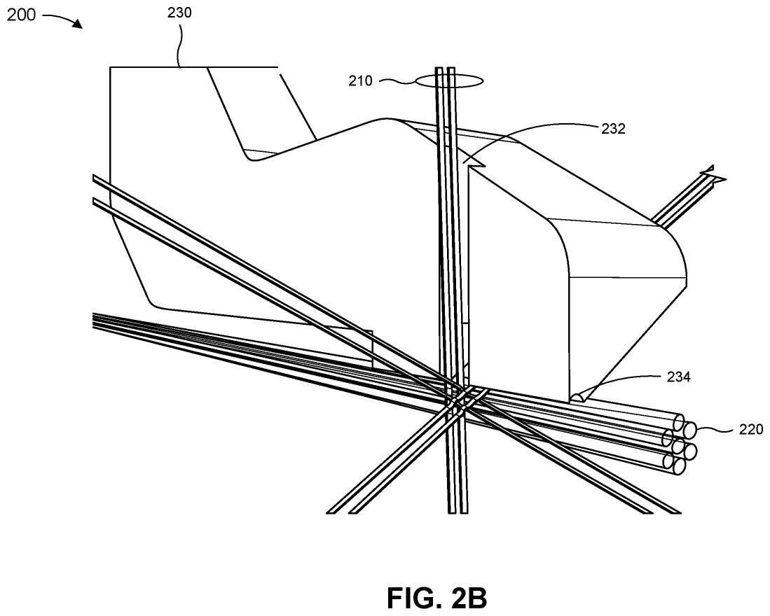

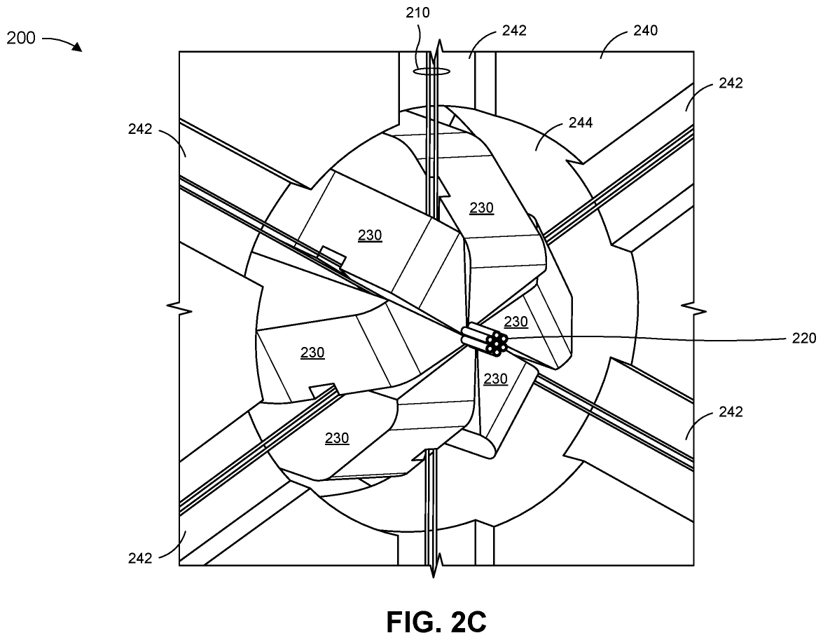

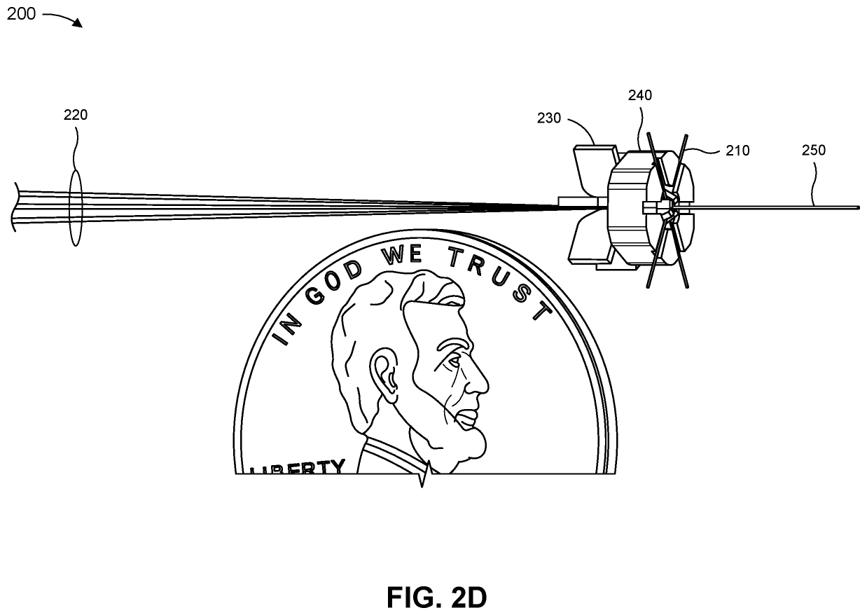

FIGS. 2A-2D are diagrams illustrating one or more examples 200 of an apparatus that can be used to simultaneously align multiple individual fibers in a fiber bundle to a multi-core fiber. In some implementations, as described herein, the apparatus may be used to align individual positions of multiple individual fibers in a first axis and a second axis (e.g., an x-axis and a y-axis) in order to fusion splice a bundle of individual fibers to a multi-core fiber. For example, the apparatus shown in FIGS. 2A-2D may use a tensegrity mechanism to enable position adjustments to individual fibers in tightly spaced fiber bundles, where “tensegrity” may generally refer to a fully-constrained geometry that uses one or more rigid members in combination with one or more purely tensioned elements. For example, the apparatus may include one or more rigid members (e.g., micro-jaw structures) that only partially constrain the individual fibers to be spliced to the multi-core fiber, and one or more purely tensioned elements (e.g., wires, ropes, cables, ribbons, filaments, fibers, or the like) that complete the fully constrained topology.

In some implementations, the multi-fiber alignment tool described herein may be used to simultaneously hold and position multiple closely spaced fibers with a submicron precision. For example, the multi-fiber alignment tool may implement tensegrity-like kinematics, in which a lattice of tensioned elements elastically constrains the positions of multiple optical fibers in a two-dimensional plane including a first axis and a second axis, while an encircling array of adjustable rigid micro-jaw structures is used to individually adjust the positions of each individual fiber (e.g., relative to one or more cores of a multi-core fiber). For example, FIG. 2A illustrates an example configuration of a lattice structure that includes a plurality of tensioned elements 210 arranged to provide a deformable support framework for a fiber bundle that includes one central fiber 220 encircled by a ring of six peripheral fibers 220. For example, in some implementations, the tensioned elements may include ultra-thin wires (e.g., flat tungsten wires that measure 4×30 microns), ropes, cables, ribbons, filaments, fibers, or other suitable tensioned elements that are used to space the fibers 220.

In the example shown in FIG. 2A, the tensioned elements 210 are arranged such that the lattice structure includes a central opening 215 for positioning the central fiber, and respective pairs of the tensioned elements 210 are each used to simultaneously position and elastically constrain one or more of the peripheral fibers 220 (e.g., in the example shown in FIG. 2A, the lattice structure includes three pairs of tensioned elements 210 that are each used to position and elastically constrain a position of two fibers 220 in the fiber bundle). In this way, with a tight spacing between the fibers 220 in the bundle, the lattice structure may elastically constrain positions of the various fibers 220 and allow for adjustment of the positions of the various fibers 220 in a two-dimensional plane (e.g., by allowing force to be applied in one direction to adjust the positions of the various fibers 220). For example, the tensioned elements 210 may be arranged in the lattice structure such that the fibers 220 can be inserted between the tensioned elements 210, which provide a deformable spring-like framework that elastically constrains the fibers 220 and allows the fibers 220 to be pushed from the outside within the lattice structure.

For example, in some implementations, the tensioned elements 210 may include wires (e.g., flat tungsten wires) or other elements that have a capability to flex under a load, which results in the lattice structure forming a spring-like and deformable holding framework for the individual fibers, which can be shifted around if pushed with the micro-jaw structures. For example, FIG. 2B illustrates an example of an individual micro-jaw structure 230, which includes a groove or recess 232 to allow the micro-jaw structure 230 to be movably adjusted along an axis of the tensioned elements 210. Furthermore, to constrain the fibers 220 tangentially, the micro-jaw structure 230 may have a concave contact profile 234 (e.g., grooved, fluted, or the like). In some implementations, the concave contact profile 234 and the spacing between the tensioned elements 210 of the lattice structure may be used for a fiber bundle where the various fibers 220 all have the same diameter, or for a fiber bundle where some of the various fibers 220 have different diameters. Accordingly, the lattice structure and the micro-jaw structures 230 fully constrain the x-axis and y-axis positions of the fibers 220 while the groove or recess 232 also allows for sliding motion in a z-axis direction. In this way, the fibers 220 can be individually aligned with a face of a target cable in the z-axis direction (e.g., using grippers that may be located down the length of the fibers 220).

FIG. 2C illustrates an example of the multi-fiber alignment tool, which may be used to simultaneously hold and manipulate the positions of multiple fibers 220 (e.g., seven fibers in the illustrated example). For example, as shown in FIG. 2C, the multi-fiber alignment tool includes a ring-like structure 240 for tensioning various tensioned elements 210, forming a lattice structure that provides a deformable support framework to simultaneously position a plurality of optical fibers 220 in a fiber bundle. For example, the ring-like structure 240 includes various grooves, recesses, or cavities 242 that the tensioned elements 210 may pass through. In this way, the plurality of optical fibers 220 may be elastically constrained in a two-dimensional plane (e.g., a first axis and a second axis, which may correspond to an x-axis and a y-axis in one example). As further shown, the multi-fiber alignment tool includes an array with various micro-jaw structures 230 passing through the lattice structure, with each micro-jaw structure 230 in the array being adjustable to shift one or more positions of one or more optical fibers 220 included in the fiber bundle relative to one or more cores of a multi-core optical fiber to be spliced to the individual optical fibers 220 forming the fiber bundle.

For example, as shown, the ring-like structure 240 may include a central cavity or opening 244 for the array of micro-jaw structures 230. In this way, each micro-jaw structure 230 in the array is adjustable to shift the position of one or more optical fibers 220 in the fiber bundle in a two-dimensional plane (e.g., an x-axis and a y-axis), while remaining optical fibers 220 in the fiber bundle are fully constrained in the two-dimensional plane and all of the optical fibers 220 are constrained in a third axis (e.g., by the combined action of the tensioned elements 210 and the micro-jaw structures 230 encircling the fiber bundle). Furthermore, in some implementations, a position of each micro-jaw structure 230 in the array may be adjustable in a first axis and a second axis with a submicron precision, with each micro-jaw structure controlling the position of a peripheral optical fiber 220 in the fiber bundle. In this way, the individual optical fibers 220 may be aligned with a pattern of optical fibers in a cable or a pattern of cores in a multi-core fiber. Accordingly, in some implementations, only the external (peripheral) fibers 220 (e.g., along an outer circumference of the fiber bundle) can interface with the micro-jaw structures 230, and the positions of the peripheral fibers 220 can be controlled directly using the corresponding micro-jaw structures 230. In such cases, the position of the central fiber 220 (if present) can be adjusted by moving the entire assembly. Additionally, or alternatively, all of the micro-jaw structures 230 and the lattice of tensioned elements 210 may be simultaneously adjusted in the first axis and the second axis to control the position of the entire pattern of the optical fibers 220 forming the fiber bundle (e.g., including any central fiber that may be present in the fiber bundle). Accordingly, aligning a fiber bundle that includes multiple individual fibers with a pattern of a cleaved multi-fiber cable or multi-core fiber would be an iterative process of forming a fiber bundle matching the pattern of the fibers in the cleaved cable or the cores in the multi-core fiber and aligning each individual fiber 220 in the bundle with the cleaved cable or multi-core fiber.

Accordingly, as shown in FIG. 2D, the multi-fiber alignment tool includes a plurality of tensioned elements 210, which may be arranged in a lattice structure to provide a deformable support framework to simultaneously position a plurality of optical fibers 220 in a fiber bundle such that the plurality of optical fibers 220 is elastically constrained in a first axis and a second axis. As further shown, the multi-fiber alignment tool includes an array including a plurality of micro-jaw structures 230 passing through the lattice structure, where each micro-jaw structure 230 is adjustable to shift one or more positions of one or more optical fibers 220 included in the fiber bundle relative to one or more cores of a multi-core optical fiber 250 (or one or more fibers in a cleaved cable). Furthermore, the multi-fiber alignment tool may include a ring-like structure 240 (or chuck) for tensioning the plurality of tensioned elements 210 inside an opening of the ring-like structure 240 and for positioning the plurality of tensioned elements 210 in a plane of the plurality of micro-jaw structures 230. In addition, FIG. 2D illustrates the multi-fiber alignment tool with reference to an object having a fixed size (e.g., a United States penny) to depict the scale of the multi-fiber alignment tool. As described herein, FIGS. 2A-2D illustrate an apparatus (e.g., multi-fiber alignment tool) that may be used to enable individual x-axis and y-axis alignment for multiple fibers 220 to be spliced to a multi-core fiber 250. Additionally, or alternatively, a second mechanism may be used in conjunction with the multi-fiber alignment tool to provide individual control of a z-axis position for each of the individual fibers 220. In some implementations, the fibers 220 that are aligned using the multi-fiber alignment tool may have the same or different diameters, and any suitable number of fibers 220 may be controlled (e.g., held and aligned) using the multi-fiber alignment tool described herein.

FIGS. 2A-2D are provided as one or more examples. Other examples may differ from what is described with regard to FIGS. 2A-2D. The number and arrangement of devices shown in FIGS. 2A-2D are provided as examples. In practice, there may be additional devices, fewer devices, different devices, or differently arranged devices than shown in FIGS. 2A-2D. Furthermore, two or more devices shown in FIGS. 2A-2D may be implemented in a single device, or a single device shown in FIGS. 2A-2D may be implemented as multiple, distributed devices. Additionally, or alternatively, a set of devices (e.g., one or more devices) shown in FIGS. 2A-2D may perform one or more functions described as being performed by another set of devices shown in FIGS. 2A-2D.

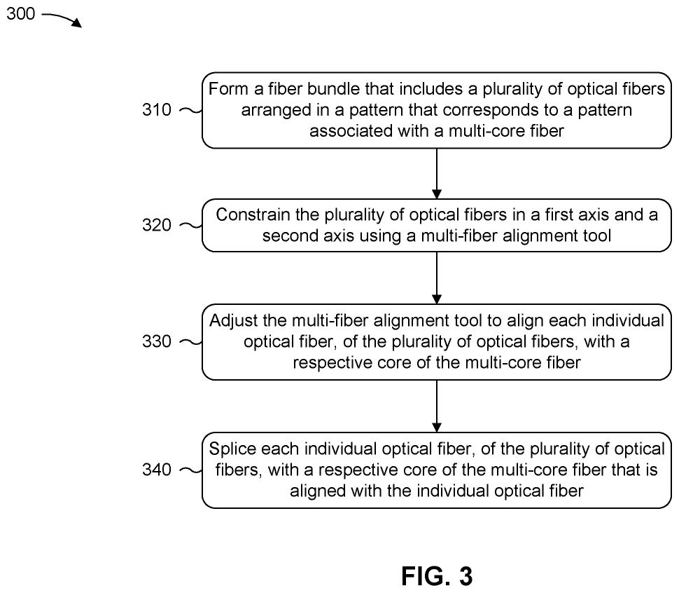

FIG. 3 is a flowchart of an example process 300 associated with aligning multiple fibers. In some implementations, one or more process blocks of FIG. 3 are performed using a multi-fiber alignment tool (e.g., the multi-fiber alignment apparatus described above with reference to FIGS. 2A-2D. In some implementations, one or more process blocks of FIG. 3 are performed by another device or a group of devices separate from or including the multi-fiber alignment tool.

As shown in FIG. 3, process 300 may include forming a fiber bundle that includes a plurality of optical fibers arranged in a pattern that corresponds to a pattern associated with a multi-core fiber (block 310).

As further shown in FIG. 3, process 300 may include constraining the plurality of optical fibers in a first axis and a second axis using a multi-fiber alignment tool (block 320). For example, in some implementations, the multi-fiber alignment tool may comprise a plurality of tensioned elements to provide a deformable support framework to simultaneously position the plurality of optical fibers such that the plurality of optical fibers is elastically constrained in the first axis and the second axis and a plurality of micro-jaw structures passing through a lattice structure that includes the plurality of tensioned elements, as described above. Accordingly, the plurality of optical fibers may be fully constrained in the first axis and the second axis by a combined action of a tensioned lattice structure that includes the plurality of tensioned elements and the various micro-jaw structures encircling the plurality of optical fibers.

As further shown in FIG. 3, process 300 may include adjusting the multi-fiber alignment tool to align each individual optical fiber, of the plurality of optical fibers, with a respective core of the multi-core fiber (block 330). For example, the device may adjust the multi-fiber alignment tool to align each individual optical fiber, of the plurality of optical fibers, with a respective core of the multi-core fiber, as described above.

As further shown in FIG. 3, process 300 may include splicing each individual optical fiber, of the plurality of optical fibers, with a respective core of the multi-core fiber that is aligned with the individual optical fiber (block 340). For example, the various individual optical fibers may be aligned with a pattern of cores in a multi-core fiber or a pattern of fibers in a cable through a first adjustment type, where the position of each micro-jaw structure is adjustable in the first axis and the second axis with a submicron precision. In such cases, each micro-jaw structure may control the position of a respective peripheral optical fiber in the fiber bundle. Additionally, or alternatively, the various individual optical fibers may be aligned with a pattern of cores in a multi-core fiber or a pattern of fibers in a cable through a second adjustment type, where all of the micro-jaw structures and the lattice of tensioned elements are simultaneously adjustable in the first axis and the second axis to control the position of the entire pattern of the fiber bundle (e.g., including the peripheral fibers and a central fiber).

Process 300 may include additional implementations, such as any single implementation or any combination of implementations described below and/or in connection with one or more other processes described elsewhere herein.

In a first implementation, adjusting the multi-fiber alignment tool comprises adjusting one or more positions for one or more micro-jaw structures, of the plurality of micro-jaw structures, in a first axis and a second axis such that each individual optical fiber, of the plurality of optical fibers, is aligned with a respective core of the multi-core fiber.

In a second implementation, alone or in combination with the first implementation, each micro-jaw structure, of the plurality of micro-jaw structures, controls a position of a respective peripheral optical fiber, of the plurality of optical fibers.

In a third implementation, alone or in combination with one or more of the first and second implementations, adjusting the multi-fiber alignment tool comprises adjusting the plurality of micro-jaw structures and the plurality of tensioned elements in a first axis and a second axis such that each individual optical fiber, of the plurality of optical fibers, is aligned with a respective core of the multi-core fiber.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An apparatus for aligning multiple fibers, comprising:
a lattice structure that comprises a plurality of tensioned elements to provide a deformable support framework to simultaneously position a plurality of optical fibers such that the plurality of optical fibers is elastically constrained in a first axis and a second axis; and
an array that comprises a plurality of micro-jaw structures passing through the lattice structure,
wherein each micro-jaw structure in the array is adjustable to shift one or more positions of one or more optical fibers included among the plurality of optical fibers relative to one or more cores of a multi-core optical fiber.

2. The apparatus of claim 1, wherein the lattice structure and the plurality of micro-jaw structures fully constrain the plurality of optical fibers in a first axis and a second axis.

3. The apparatus of claim 1, wherein each micro-jaw structure in the array is adjustable to shift one or more positions of one or more optical fibers, of the plurality of optical fibers, in the first axis and the second axis while a remaining one or more optical fibers, of the plurality of optical fibers, are fully constrained in the first axis and the second axis and all of the plurality of optical fibers are constrained in a third axis.

4. The apparatus of claim 1, wherein the plurality of micro-jaw structures each have a concave contact profile to tangentially constrain a respective optical fiber, of the plurality of optical fibers, in the first axis and the second axis.

5. The apparatus of claim 1, further comprising:
a ring-like structure for tensioning the plurality of tensioned elements inside an opening of the ring-like structure and for positioning the plurality of tensioned elements in a plane of the plurality of micro-jaw structures.

6. The apparatus of claim 1, wherein the plurality of optical fibers are arranged in a pattern encircling a central fiber and passing through the plurality of tensioned elements.

7. The apparatus of claim 6, wherein the pattern includes one or more rings encircling the central fiber.

8. The apparatus of claim 1, wherein the plurality of optical fibers have identical diameters.

9. The apparatus of claim 1, wherein the plurality of optical fibers includes two or more optical fibers that have different diameters.

10. A method for aligning multiple fibers, comprising:
forming a fiber bundle that includes a plurality of optical fibers arranged in a pattern that corresponds to a pattern associated with a multi-core fiber;
constraining the plurality of optical fibers in a first axis and a second axis using a multi-fiber alignment tool, wherein the multi-fiber alignment tool comprises:
a plurality of tensioned elements to provide a deformable support framework to simultaneously position the plurality of optical fibers such that the plurality of optical fibers is elastically constrained in the first axis and the second axis; and
a plurality of micro-jaw structures passing through a lattice structure that includes the plurality of tensioned elements;
adjusting the multi-fiber alignment tool to align each individual optical fiber, of the plurality of optical fibers, with a respective core of the multi-core fiber; and
splicing each individual optical fiber, of the plurality of optical fibers, with a respective core of the multi-core fiber that is aligned with the individual optical fiber.

11. The method of claim 10, wherein adjusting the multi-fiber alignment tool comprises: adjusting one or more positions for one or more micro-jaw structures, of the plurality of micro-jaw structures, in a first axis and a second axis such that each individual optical fiber, of the plurality of optical fibers, is aligned with a respective core of the multi-core fiber.

12. The method of claim 11, wherein each micro-jaw structure, of the plurality of micro-jaw structures, controls a position of a respective peripheral optical fiber, of the plurality of optical fibers.

13. The method of claim 10, wherein adjusting the multi-fiber alignment tool comprises: adjusting the plurality of micro-jaw structures and the plurality of tensioned elements in a first axis and a second axis such that each individual optical fiber, of the plurality of optical fibers, is aligned with a respective core of the multi-core fiber.

14. A multi-fiber alignment system, comprising:
a plurality of tensioned elements to provide a deformable support framework to simultaneously position a plurality of optical fibers such that the plurality of optical fibers is elastically constrained in a first axis and a second axis;
a plurality of micro-jaw structures passing through a lattice structure,
wherein each micro-jaw structure, of the plurality of micro-jaw structures, is adjustable to shift one or more positions of one or more optical fibers included among the plurality of optical fibers relative to one or more cores of a multi-core optical fiber; and
a ring-like structure for tensioning the plurality of tensioned elements inside an opening of the ring-like structure and for positioning the plurality of tensioned elements in a plane of the plurality of micro-jaw structures.

15. The multi-fiber alignment system of claim 14, wherein the lattice structure and the plurality of micro-jaw structures fully constrain the plurality of optical fibers in a first axis and a second axis.

16. The multi-fiber alignment system of claim 14, wherein each micro-jaw structure is adjustable to shift the position of a subset of optical fibers included among the plurality of optical fibers in the first axis and the second axis while a remaining subset of optical fibers in the plurality of optical fibers is fully constrained in the first axis and the second axis and all of the plurality of optical fibers are constrained in a third axis.

17. The multi-fiber alignment system of claim 14, wherein the plurality of micro-jaw structures each have a concave contact profile to tangentially constrain a respective optical fiber, of the plurality of optical fibers, in the first axis and the second axis.

18. The multi-fiber alignment system of claim 14, wherein the plurality of optical fibers are arranged in a pattern encircling a central fiber and passing through the plurality of tensioned elements.

19. The multi-fiber alignment system of claim 14, wherein the plurality of optical fibers have identical diameters.

20. The multi-fiber alignment system of claim 14, wherein the plurality of optical fibers includes two or more optical fibers that have different diameters.
